(19) United States
(12) Patent Application Publication
(10) Pub. No.: US 2016/0125571 A1
(43) Pub. Date: May 5, 2016

(54) IMAGE PROCESSING APPARATUS

(71) Applicants: KABUSHIKI KAISHA TOSHIBA, Tokyo (JP); Toshiba Lifestyle Products & Services Corporation, Tokyo (JP)

(72) Inventor: Katsuya Ohno, Kokubunji Tokyo (JP)

(21) Appl. No.: 14/878,779

(22) Filed: Oct. 8, 2015

Related U.S. Application Data
(60) Provisional application No. 62/072,248, filed on Oct. 29, 2014.

(51) Int. Cl. G06T 3/40; G06F 3/01; G09G 5/00

(52) U.S. Cl. CPC G06T 3/40; G09G 5/003; G06F 3/011; G09G 2340/0478

(57) ABSTRACT

According to one embodiment, an image processing apparatus includes a display formed of a flat panel and configured to display a video image, and a display controller configured to generate a curved image and output, to the display, a display signal for displaying the curved image. The curved image is obtained by reducing and deforming an input image. The display controller reduces the input image by a maximum reduction ratio in a predetermined position, and reduces the input image by a smaller reduction ratio in a position remoter from the predetermined position.

### CROSS-REFERENCE TO RELATED APPLICATIONS

This application claims the benefit of U.S. Provisional Application No. 62/072,248, filed Oct. 29, 2014, the entire contents of which are incorporated herein by reference.

### FIELD

Embodiments described herein relate generally to an image processing apparatus.

### BACKGROUND

Digital televisions (DTVs) with curved displays have recently been developed. The DTVs with curved displays can provide more realistic images than DTVs with flat displays. However, the DTVs with curved display's require a larger installation area than the DTVs with flat displays, and involve such an installation problem that they are hard to hang on a wall. Further, the DTVs with curved displays are fixed in shape, and are therefore fixed in position to realize optimal viewing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a front view showing an example of an image processing apparatus according to a first embodiment;

FIG. 2 is a block diagram showing a configuration of the image processing apparatus according to the first embodiment;

FIG. 3 is a view for explaining an example of image processing in a display controller according to the first embodiment;

FIG. 4 is a schematic view showing an example case where an observer stands in front of the image processing apparatus;

FIG. 5A is a schematic view for explaining an example of a curved image obtained when an observer exists far away from a display;

FIG. 5B shows the curved image example obtained in the case of FIG. 5A;

FIG. 6A is a schematic view for explaining an example of a curved image obtained when an observer exists near the display;

FIG. 6B shows the curved image example obtained in the case of FIG. 6A;

FIG. 7A is a schematic view for explaining an example of a curved image obtained when an observer observes the display at an end of the longitudinal axis;

FIG. 7B shows the curved image example obtained in the case of FIG. 7A;

FIG. 8 is a flowchart for setting the curvature of a curved image in accordance with the position of the observer;

FIG. 9 shows a modification of the first embodiment;

FIG. 10 shows another modification of the first embodiment;

FIG. 11 is a block diagram showing a configuration of an image processing apparatus according to a second embodiment;

FIG. 12 is a schematic view showing an example case where an observer stands in front of an image processing apparatus;

FIG. 13A is a schematic view for explaining an example of a curved image obtained when an observer exists near a display;

FIG. 13B shows the curved image example obtained in the case of FIG. 13A;

FIG. 14 is a flowchart for setting the curvature of a curved video image in accordance with the observation point of an observer;

FIG. 15 is a block diagram showing a configuration of an image processing apparatus according to a third embodiment;

FIG. 16A is a schematic view for explaining an example of a curved video image obtained when content to display has been changed;

FIG. 16B shows the curved video image example obtained in the case of FIG. 16A; and

FIG. 17 is a flowchart for setting the curvature of a curved video image in accordance with the type of content to display.

### DETAILED DESCRIPTION

In general, according to one embodiment, an image processing apparatus comprising: a display formed of a flat panel and configured to display a video image; and a display controller configured to generate a curved image and output, to the display, a display signal for displaying the curved image, the curved image being obtained by reducing and deforming an input image included in an input video signal in accordance with a horizontal position of the input image, to curve the input image perpendicularly, wherein the display controller reduces the input image by a maximum reduction ratio in a predetermined horizontal position, and reduces the input image by a smaller reduction ratio in a horizontal position remoter from the predetermined horizontal position.

Embodiments will be described with reference to the accompanying drawings.

### First Embodiment

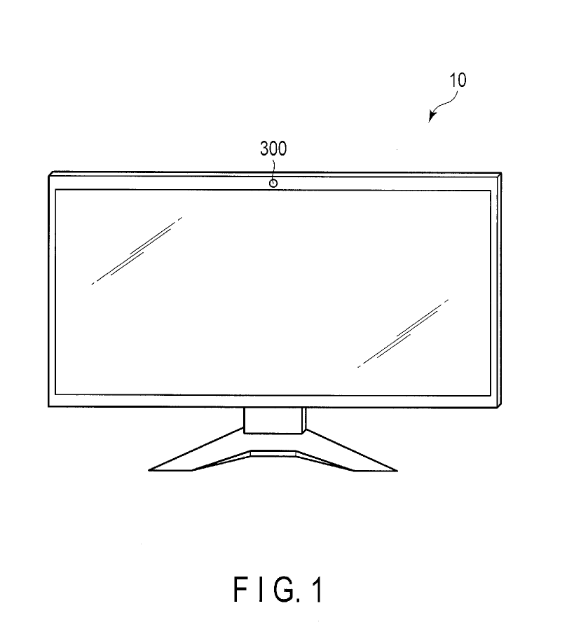

FIG. 1 is a front view showing an example of an image processing apparatus according to a first embodiment. An image processing apparatus 10 according to the first embodiment comprises a detector 300. The image processing apparatus 10 outputs curved video and still images and displays realistic images of wide view angles. The image processing apparatus 10 is realized as, for example, a television (TV) receiver, a personal computer (PC), a home server, a DVD/HDD recorder, etc. In the description below, the image processing apparatus 10 is supposed to be a TV receiver.

The image processing apparatus 10 receives TV programs of ground-based, cable, BS and CS broadcasts, etc. The image processing apparatus 10 is connected to an external device by radio or fixed line to thereby transmit and receive information. For instance, the image processing apparatus 10 may be connected to, for example, the Internet.

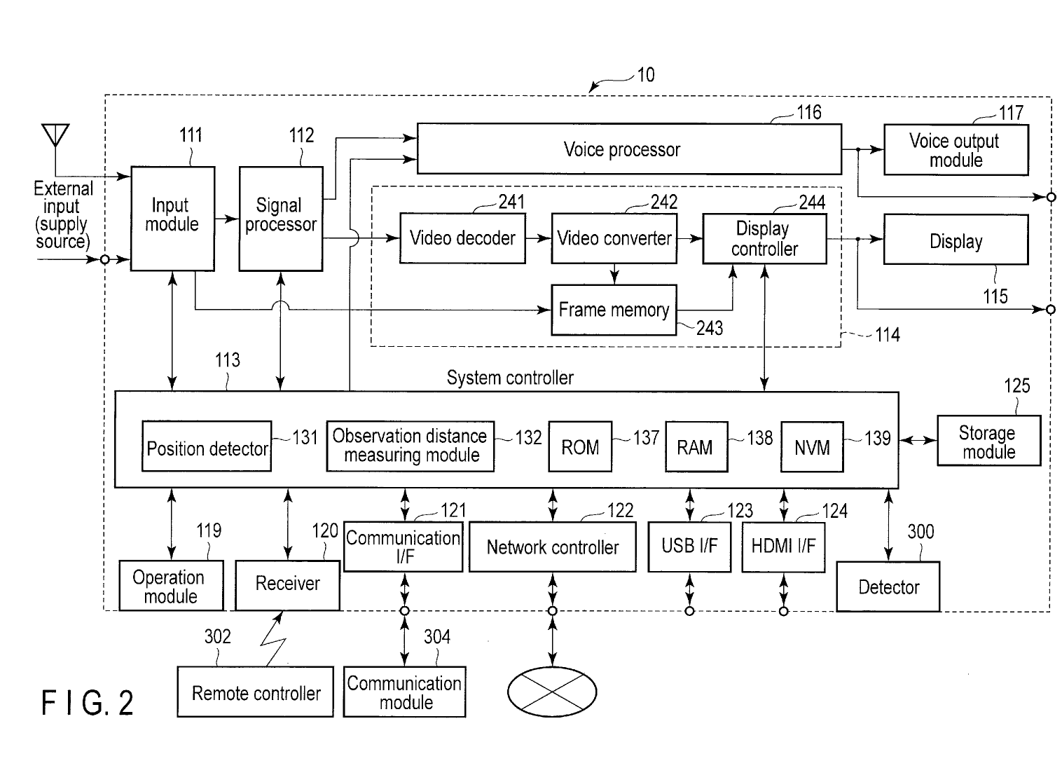

FIG. 2 is a block diagram showing a configuration of the image processing apparatus 10 according to the first embodiment.

The image processing apparatus 10 of the first embodiment comprises an input unit 111, a signal processor 112, a system controller (controller) 113, a video processor 114, a display 115, a voice processor 116, a voice output unit 117, an operation unit 119, a receiver 120, a communication interface 121, a network controller 122, a USB interface 123, an HDMI interface 124, a storage unit 125 and a detector 300. The image processing apparatus 10 is communicable with a remote controller 302 and connected to a communication unit 304.

The input unit 111 comprises an antenna for receiving broadcasts, tuners for selecting received signals, a descrambler for pre-processing programs, etc. The input unit 111 is connected to the antenna to receive programs from broadcast enterprises via space waves. Further, the input unit 111 receives programs from delivery enterprises via a network. The input unit 111 receives a broadcast stream (broadcast signal) to select one or more broadcast programs and then convert it into a broadcast stream usable in the signal processor 112. The input unit 111 sends all received programs of predetermined channels to the signal processor 112.

The signal processor 112 separates program attendant information multiplexed in the received broadcast signal, and outputs the separated program attendant information to the video processor 114 (video decoder 241). The signal processor 112 also outputs a recording stream to the controller 113 described later. The recording stream is information obtained by separating, in the signal processor 112, the program attendant information from the broadcast stream received by the input unit 111. The signal processor 112 separates the broadcast signal sent from the input unit 111 into a video signal, an audio signal and control information. The video processor 112 outputs the video signal to the video processor 114, and outputs the audio signal to the voice processor 116. At this time, if externally input signals received from the receiver 120 are, for example, video and audio signals output from a video camera, separation by the signal processor 112 may not be needed.

The system controller (controller) 113 controls each element of the image processing apparatus 10. Namely, the controller 113 controls the input unit 111, the signal processor 112, the video processor 114, the display 115, the voice processor 116, the voice output unit 117, the operation unit 119, the receiver 120, the communication interface (I/F) 121, the network controller 122, the USB interface (I/F) 123, the HDMI interface 124, the storage unit 125 and the detector 300. The controller 113 outputs various control commands corresponding to input signals (operation instruction signals) received by the receiver 120, described later, from the remote controller 302 or a mobile terminal, such as a smartphone, a mobile phone, a tablet or a note PC. The control commands are those for instructing, recording of a TV broadcast (program), replay of recorded content (program), etc.

The controller 113 comprises a position detector 131, an observation distance measuring unit 132, a ROM 134, a RAM 135 and an NVM 136.

The position detector 131 detects the position of an object existing in a predetermined area, identifies the type and/or state of the detected object, and outputs, as position information, information indicative of the detected and identified object.

The position detector 131 automatically detects the position of an object based on a signal from the controller 113. Further, the position detector 131 can detect the position of an object at arbitrary timing. The predetermined area means a preset area or an automatically set area. The preset area is, for example, an area that can be detected by the detector 300 described later. Based on detection data obtained from the detector 300, a person existing in the predetermined area is detected, and it is determined whether this person is observing (viewing) the display 115.

The position detector 131 arbitrarily sets an observer based on a signal from the controller 113. For instance, the position detector 131 causes the display 115 to display the detected person, and a user sets an observer using, for example, the remote controller 302. Further, the position detector 131 sets the detected person as an observer (viewer). In this case, the position detector 131 may set, as the observer, a person who is observing the display 115 for a predetermined period of time in the area detected by the detector 300.

The position detector 131 may detect the position of an object based on data differing from the data provided by the detector 300, and identifies the type or state of the object. For instance, the position detector 131 may detect an object based on data acquired by a sensor.

The observation (viewing) distance measuring unit 132 calculates the distance between a preset position and the position of the display 115. The preset position may be an arbitrarily set position or a regularly automatically detected position. The preset position is, for example, the position (observation position) of an observer who observes the display 115, and is, for example, the position of the head or eyes of the observer. The preset position may be obtained from detection data obtained by the position detector 131, or be set by the user. Further, the position of the display 115 is preset as, for example, the position of the screen surface of the display 115, the center of the thickness of the display 115, or the surface of the display 115 to which the visual axis of the observer is directed.

The observation distance measuring unit 132 calculates an observation distance, and stores the calculated observation distance as distance information in the storage unit 125.

The ROM (read only memory) 137 holds a control program executed by the controller 13. The RAM (access random memory (work memory)) 138 provides a work area for the system controller 113.

The NVM (nonvolatile memory) 139 holds various types of setting information and control information in the image processing apparatus 10. The NVM 139 can also hold the structure content information of a program table.

The video processor 114 comprises a video decoder 241, a video converter 242, a frame memory 243 and a display controller 244.

The video decoder 241 decodes a video signal separated by the signal processor 112, and outputs the decoded signal as a digital video signal (video output) to the video converter 242.

The video converter 242 converts the video signal decoded by the video decoder 241 into a signal of a predetermined resolution and an output scheme that can be displayed on the display 115. The video converter 242 stores the converted video signal in the frame memory 243 in accordance with a signal from the controller 113, and outputs it to the display controller 244.

The frame memory 243 stores, for processing, video data (signal) received from the input unit 111, and video data received from the video converter 242.

The display controller 244 converts an input video signal, i.e., images included in a single video image stream, into a display signal that can be appropriately displayed (video reproduction) by the display 115. The display controller 244 arbitrarily or automatically converts, into a display signal, a video signal output from the video converter 242 in accordance with a signal supplied from the controller 113, and outputs the resultant signal to the display 115.

Further, the display controller 244 extracts an arbitrary image from the images included in the video signal sent from the frame memory 243, and defines the extracted image as (divides into) images (primary images) belonging to a plurality of zones. The display controller 244 executes image processing on each of the primary images defined in the respective zones, and appropriately rearranges secondary images resulting from image processing on the primary images. The display controller 244 defines a set of rearranged secondary images as a curved image. When outputting a set of thus-defined curved images as a video image, the display controller 244 temporarily sequentially arranges a plurality of images generated by image processing, and converts them into a display signal indicative of a video image. The image processing includes, for example, expansion, reduction and deformation of images, and changes in the brightness, hue, contrast, quality, resolution, etc., of images. The zones defined for each image by the display controller 244 may have the same size or different sizes. In the description below, parts of the image, for which the display controller 244 defines zones, are referred to as the primary images, and parts of the image, for which zones are defined after processing the primary images, are referred to as the secondary images.

When rearranging the secondary images, the display controller 244 performs image processing so that the boundaries of the zone of each secondary image will contact opposing boundaries of the zones of corresponding adjacent secondary images. At this time, adjustment is performed to suppress image distortion at the boundaries of the respective pairs of adjacent secondary images.

The display controller 244 can arbitrarily set, for example, a to-be-processed image in the images indicated by a video signal, defined (divided) zones of the image, the type of image processing to execute, adjustment of images, and an image to output, in accordance with an instruction signal, or can automatically set them in accordance with an instruction signal from the controller 113. Further, the display controller 244 can control the content of image processing for each image whose zones are defined.

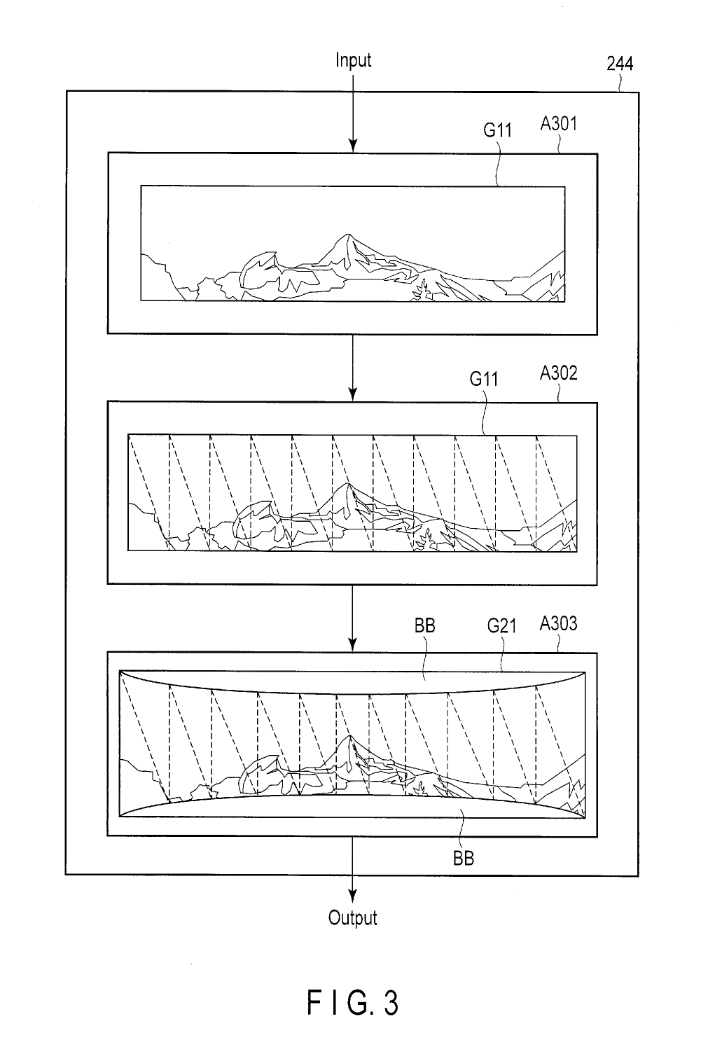

FIG. 3 shows an example of image processing performed by the display controller 244. Referring to FIG. 3, the example of image processing performed by the display controller 244 will be described.

In the embodiment, each image is an image displayed to be fit in the rectangular display 115, and has a major axis and a minor axis. Each image may be a square one. In this case, in the display area of the display 115 having the major and minor axes, an arbitrary background image, such as a black band, is displayed in the area in which no image is displayed.

In image processing A301, the display controller 244 acquires image G11 from the frame memory 243.

In subsequent image processing A302, the display controller 244 defines image G11 as a plurality of zones. For instance, the display controller 244 defines image zones using triangular polygons as indicated by the broken lines in FIG. 3. For instance, parts of the image defined by the triangular polygons are primary images. By thus partitioning input image G11 using triangular polygons, the display controller 244 can output a substantially curved image. Although in the embodiment, the zones of an image are defined by triangular polygons, the shape of the polygons defining the zones of the image can be set arbitrarily. For instance, polygons of a square or rectangular shape may be used to define the zones of the image.

In image processing A303, the display controller 244 executes predetermined processing on each of the primary images defined in image G11 by image processing A302. Namely, the display controller 244 provides a curved image of a predetermined curvature by processing each primary image partitioned by triangular polygons and rearranging the resultant secondary images.

At the time of rearrangement, the display controller 244 rearranges the secondary images so as to obtain a curved image that is greatly curved like hyperbolic curves along a longitudinal axis with reference to a secondary image located at a point at which the substantial hyperbolic curves most approach each other. The secondary image as the reference of the curves is more reduced and deformed than a maximum reduction ratio among the primary images defined in one image. Namely, the secondary images have deformation ratios that relatively increase as the secondary images are away along the longitudinal axis (horizontal axis) from the secondary image located at the above-mentioned point (reference point). The display controller 244 rearranges the secondary images to form a curved image that has an upwardly projecting lower end at a position along the longitudinal axis (horizontal axis) of the display area, and has a downwardly projecting upper end at the same position as the above. The upper and lower curves have the same curvature variation. For instance, the display controller 244 generates a curved image, at a center portion of which the curves project to approach each other. In the image, an axis perpendicular to the longitudinal axis is set as a transverse (perpendicular) axis. Further, the ratio of reduction is a deformation ratio indicative of a ratio with which each secondary image is reduced with respect to a corresponding primary image.

When forming a curved image curved along a certain axis, the display controller 244 can output a display signal indicative of a smoothly curved video image by setting (defining) a larger number of polygons for secondary images that are remoter, along the longitudinal axis, from the secondary image serving as a reference for curving.

Further, in image processing A303, the display controller 244 rearranges secondary images so that they are curved to the opposite ends of image G21 furthest from the center portion thereof located at the above-mentioned point, thereby setting the set of rearranged secondary images as a curved image. For instance, in image G21, the secondary image located at the center of the curved image is most reduced and deformed, while the two secondary images located at the opposite ends along the longitudinal axis of the display area are maintained at the original size assumed when they are input. In image G21, a black band BB is provided in, for example, an extra portion where no image is provided. After finishing image processing, the display controller 244 converts processed image G21 into a display signal, and outputs the resultant signal to the display 115.

The display 115 displays, as a video image, the display signal received from the display controller 244. When the display signal output from the display 115 constructs a curved video image (curved image), the display 115 displays the curved video image (curved image). For instance, if a display signal corresponding to a video image formed of a curved image like image G21 of FIG. 3 is input, the display 115 displays a curved video image like image G21. The display 115 is, for example, a flat-type display having a flat panel, and is formed rectangular to have short and long axes. The display surface of the display is formed flat.

The voice processor 116 decodes an audio signal in a program received by the input unit 111, and outputs the resultant signal to the voice output unit 117.

The voice output unit 117 outputs an audio signal decoded by the voice processor 116. The voice output unit 117 is, for example, a loud speaker.

The operation unit 119 inputs, to the controller 113, a control command corresponding to a direct operation by a user.

The receiver 120 inputs, to the controller 113, a control command corresponding to a signal received from an external device, such as the remote controller 302 and a mobile terminal. The receiver 120 inputs an operation instruction, received from the remote controller 302, to the controller 113.

The communication interface 121 realizes wireless communication with a short-range wireless communication device based on, for example, WiFi (Wireless Fidelity). As the short-range wireless communication standard, Bluetooth (trademark) or Near Field Communication (NFC) is usable. The communication interface 121 may be of either wired scheme or wireless scheme, and is connected to, for example, a communication unit capable of transceiving signals from and to, for example, a wireless keyboard or a mouse. Further, the communication interface 121 communicates with a short-range wireless communication device via, for example, the communication unit 304. The communication unit 304 is a terminal for performing wireless communication based on, for example, WiFi. Specifically, the communication unit 304 is, for example, a card reader capable of communicating with a noncontact card medium.

The network controller 122 controls access to an external network, such as the Internet. The network controller 122 transmits and receives information through the Internet.

The USB interface 123 is connected to an external device, such as a keyboard 306, compliant with the USB standards.

The HDMI interface 124 enables wired communication between a plurality of devices based on the HDMI or MHL standards.

The storage device 125 stores information associated with various types of setting and data, various set values, information indicative of curved video images, and data associated with, for example, setting for curved video images corresponding to various types of content. The storage device 125 is, for example, a hard disk drive (HDD).

The detector 300 includes, for example, various types of sensors. For instance, the detector 300 is a camera with an image sensor. When the detector 300 is, for example, a small camera, it detects an object(s) around the image processing apparatus 10. The detector 300 is installed such that it can detect a predetermined area (detection area). The detector 300 detects, for example, an area in which an image on the display 115 is observed. A plurality of detectors 300 may be installed. The detector 300 detects detection data based on a signal from the controller 113. The detector 300 stores the detected data in the storage unit 125. The detection data includes data indicative of the position of a target (e.g., an observer), data indicative of the state of the target, data indicative of a person identification result, data associated with ambient video images and/or ambient images, etc.

The remote controller 302 sends an operation instruction from the user, to the controller 113 via the receiver 120. The remote controller 302 accepts an operation instruction via, for example, a button. The remote controller 302 outputs various operation instructions input by the user, such as an instruction to set the curvature of a video image (the curvature of a curved image), an instruction to set the position of the observer or the display 115, an instruction to adjust a video image, and an instruction to start detection.

The curvature of a curved video image detected in an observation position will be described. In general, in order to obtain a wide view angle and enhance presence, it is preferable to set the curvature of a curved video image small when the observer exists away from the display 115, and to set it large when the observer exists near the display 115. It should be noted here that although in the figures, some curved video images (curved images) are indicated by curved lines in order to show their curvatures, they are actually displayed on the display 115 that has a flat surface. Further, broken lines, which are displayed on each displayed image, merely indicate a process that the image was partitioned and then subjected to processing. Actually, however, these broken lines are not displayed on the image.

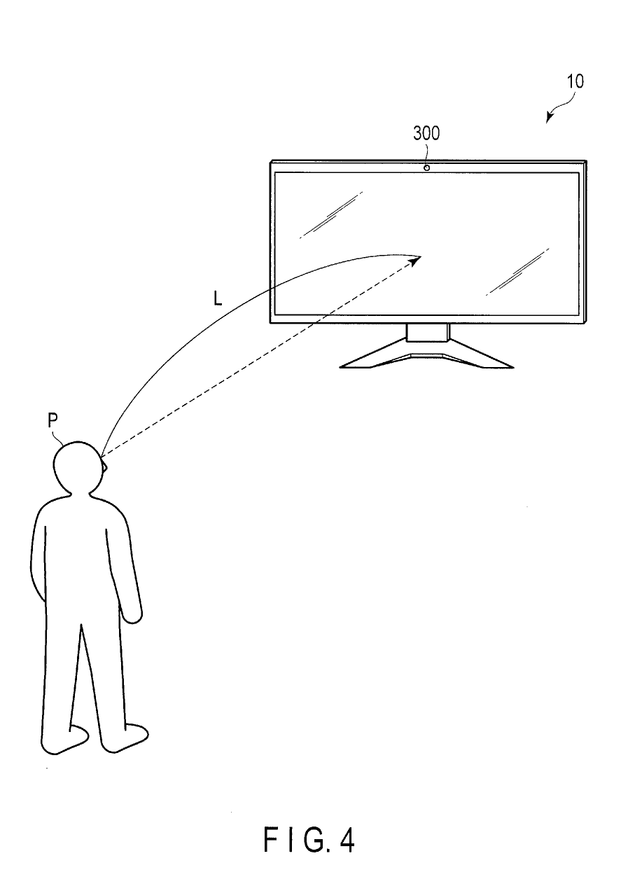

FIG. 4 is a schematic view showing an example case where an observer stands in front of the image processing apparatus. Assume here that the observer is observing the display 115 in a position P at a distance L from the display 115. For instance, the observer is assumed to stand in a direction perpendicular to the center of the display 115.

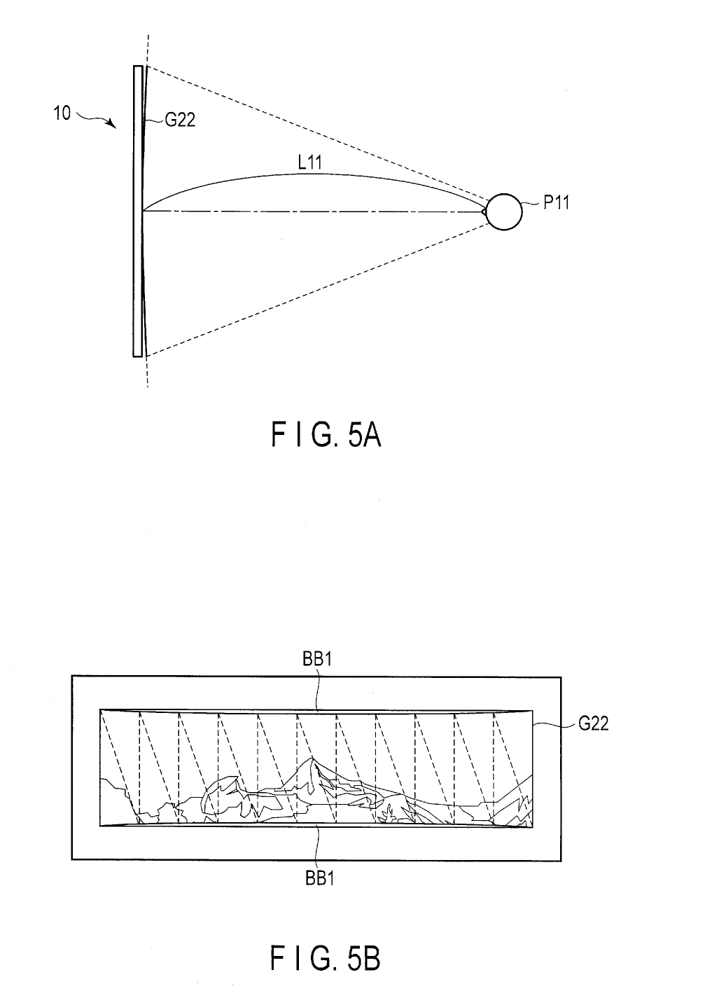

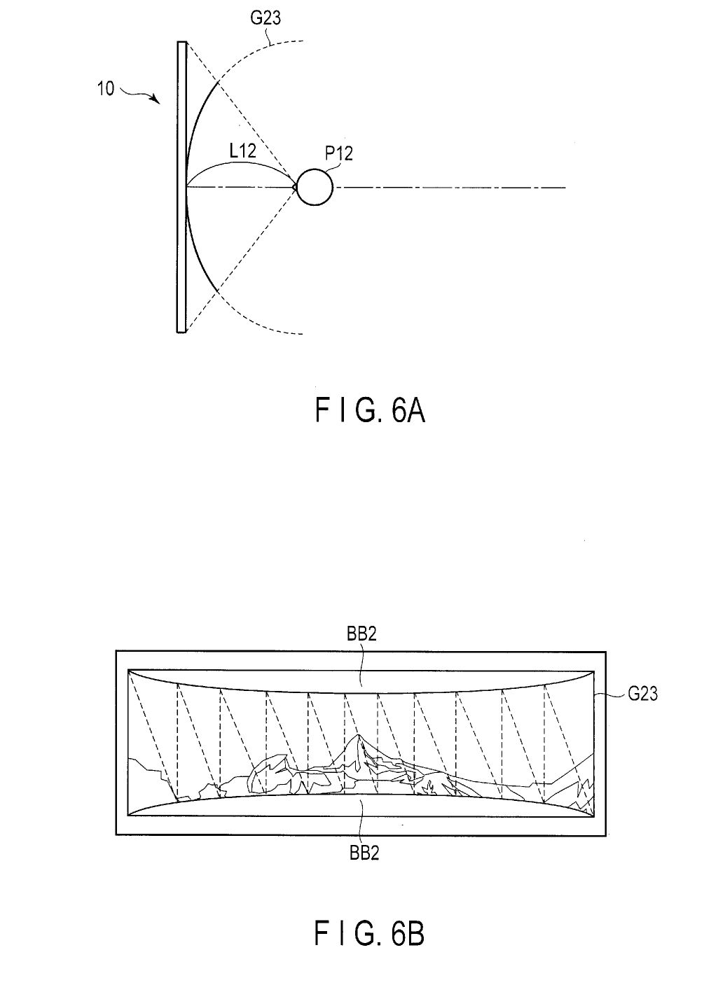

FIG. 5A is a schematic view for explaining an example of a curved image obtained when the observer exists far away from the display 115. FIG. 5B shows the curved image example obtained in the case of FIG. 5A. FIG. 6A is a schematic view for explaining an example of a curved image obtained when the observer exists near the display. FIG. 6B shows the curved image example obtained in the case of FIG. 6A. In FIGS. 5A to 6B, assume that the conditions other than the distance between the observer and the display 115 are substantially the same.

In FIG. 5A, the observer exists away from the center of the display 115 in a direction perpendicular thereto. Namely, observation position P11 is assumed to be at far distance L11 from the center of the display 115 as shown in FIG. 5A. In this case, the curvature of the curved video image is arbitrarily set small, or automatically set small by the controller 113, to obtain a wide view angle and enhance the presence. In FIG. 5A, the curvature of curved video image (curved image) G22 processed by the display controller 244 is 1/L11.

In FIG. 5B, the curved video image is processed so that it is curved along the longitudinal axis from the position in which the curves (substantial hyperbolic curves) defining the picture most approach each other. When observation position P11 is at far distance L11 from the display 115 as shown in FIG. 5B, the curvature of the curved video image is arbitrarily or automatically set small. As a result, black bands BB1 of the display area also become small as shown in FIG. 5B.

In FIG. 6A, the observer exists in position P12 near the center of the display 115 in a direction perpendicular to the center. Namely, observation position P12 is assumed to be at short distance L12 (L11>L12) from the center of the display 115 as shown in FIG. 6A. In this case, the curvature of the curved video image is arbitrarily set large, or automatically set large by the controller 113, to obtain a wide view angle and enhance the presence. In FIG. 6A, the curvature of curved video image (curved image) G23 processed by the display controller 244 is 1/L12.

In FIG. 6B, the curved video image is processed so that it is curved along the longitudinal axis from the position in which the curves (hyperbolic curves) most approach each other, like the curved video image of FIG. 5B. When first distance P12 is short distance L12 from the display 115 as shown in FIG. 6B, the curvature of the curved video image is arbitrarily set large, or automatically set large by the controller 113. As a result, black bands BB1 of the display area also become large as shown in FIG. 6B.

As shown in FIGS. 5A, 5B, 6A and 6B, when the observer is near and away from the display 115, the curvature of the curved video image is set large and small by the controller 113, respectively, if the other conditions are the same. Namely, the curvature associated with distance is set by the controller 113 1/L12>1/L11 in order to obtain a wide view angle and enhance presence.

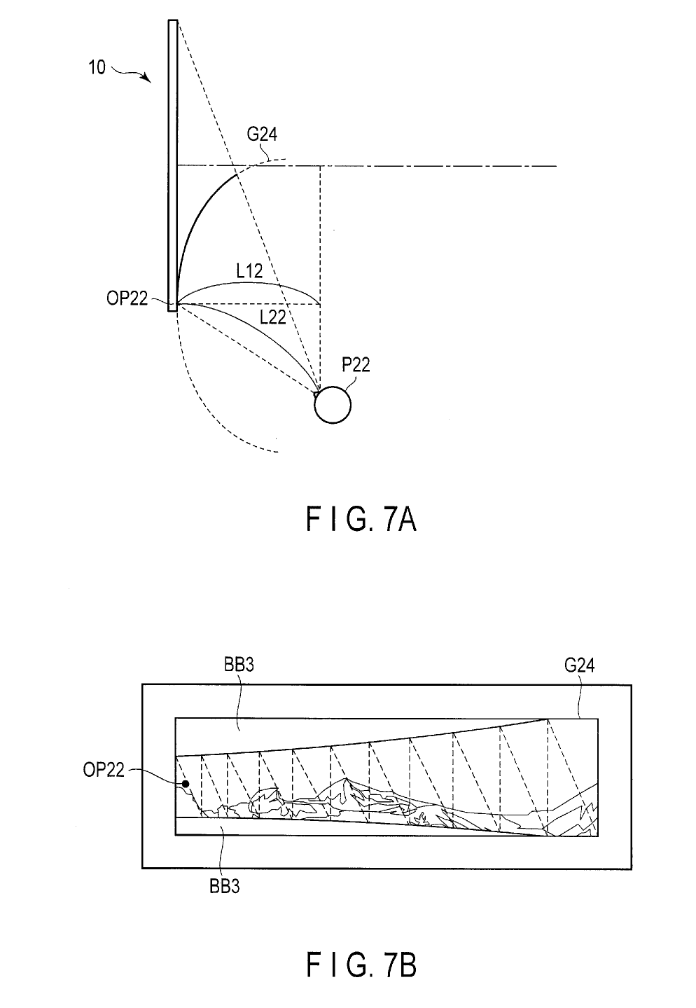

FIG. 7A is a schematic view for explaining an example of a curved image obtained when the observer observes the display at an end of the longitudinal axis. FIG. 7B shows the curved image example obtained in the case of FIG. 7A.

In FIG. 7A, the observer exists in position P22 close to a longitudinal end of the display 115. In FIG. 7A, position P22 is assumed to be obtained when the observer moves parallel from the position of FIG. 6A along the longitudinal axis of the display 115, and to be positioned outside of the longitudinal end of the image processing apparatus 10. Namely, it is assumed that observation position P22 is at linear distance L22 from the longitudinal end of the display 115 as shown in FIG. 7A. In this case, the controller 113 sets substantially the same curvature as in FIGS. 6A and 6B to provide a realistic curved image of a wide view angle. Accordingly, the curvature of curved video image (curved image) G24 processed by the display controller 244 is 1/L12.

Further, since in this case, the longitudinal position of the observer is changed, the display controller 244 resets the position of the vertically smallest portion of a curved image observed by the observer, in order to provide a realistic curved image of a wide view angle suitable for the observation position. Namely, the display controller 244 constructs curved image G24 so that the vertically smallest portion of the image is positioned at a longitudinal end close to the observer.

In FIG. 7B, the display controller 244 constructs a curved video image so that the picture is curved from the one longitudinal end of the display 115 to the other longitudinal end. When observation position P22 is positioned outside the longitudinal end of the image processing apparatus 10, the controller 113 arbitrarily or automatically sets the curvature of the curved image in accordance with a distance perpendicular to the display 115, to make the vertically smallest portion of the curved image be positioned closest to observation position P22 as shown in FIG. 7B. Further, as shown in FIG. 7B, black bands BB3 around the displayed image are curved by the display controller 244 to be reduced in size as they are longitudinally away from the vertically smallest portion of the curved image.

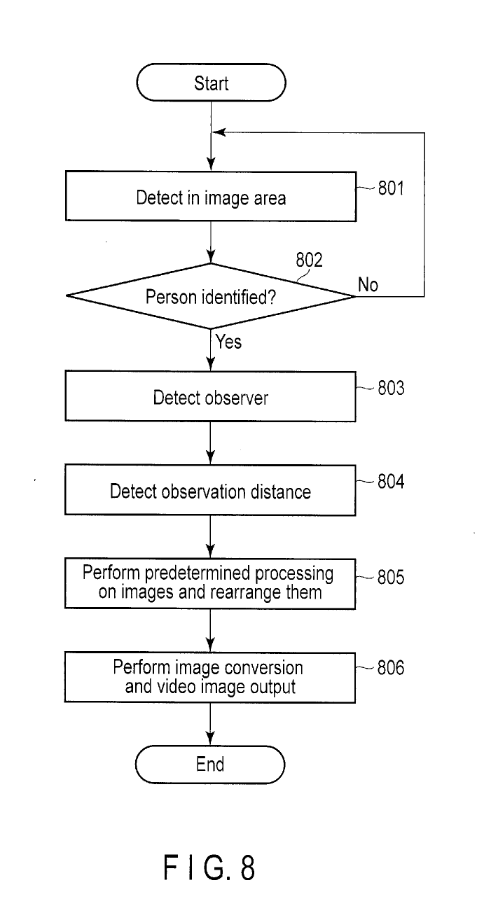

Referring then to FIG. 8, a description will be given of a method of automatically setting the curvature of a curved video image using the controller 113, based on detection data obtained by the detector 300.

FIG. 8 is a flowchart used by the controller 113 to set the curvature of a curved video image in accordance with the observation position.

In B801, the position detector 131 of the controller 113 detects an object in a detection area, using the detector 300. The position detector 131 detects an object in, for example, the detection area that is detected in a real-time by the detector 300.

If in B802, the position detector 131 detects a person in the detected object (Yes in B802), subsequent processing (B803) is performed. In contrast, if no person is detected (No in B802), the position detector 131 again attempts to detect a person in the object detected in the detection area.

In B803, the position detector 131 detects whether the detected person is observing the display 115, and sets, as an observer, a person who is observing the display 115.

Subsequently, in B804, the observation distance measuring unit 132 of the controller 113 sets an observation position from information acquired by the position detector 131, and calculates an observation distance from information acquired by the detector 300.

In B805, the display controller 244 defines, as primary images, images acquired from the frame memory 243 in respective predetermined zones under the control of the controller 113, and performs predetermined processing in each of the primary images. The display controller 244 appropriately rearranges secondary images obtained by processing the primary images of the respective zones, and sets a set of rearranged secondary image as a curved image.

In B806, the display controller 244 outputs a display signal indicative of the processed image to the display 115.

In the first embodiment, the image processing apparatus 10 displays a curved video image on the flat display 115. Further, the image processing apparatus 10 performs predetermined processing, under the control of the controller 113, on each of the primary images obtained by dividing processing using polygons, appropriately rearranges the processed images, and provides the rearranged images as a smooth curved image. The image processing apparatus 10 displays the thus-formed curved image on the display 115. As a result, the image processing apparatus 10 can provide realistic images of a wide view angle.

Moreover, the image processing apparatus 10 can arbitrarily set the position of the vertically smallest portion of the curved image and the curvature of the curved image in accordance with an instruction from, for example, the remote controller 302. As a result, the curvature can be set in accordance with the taste of the observer, regardless of the observation distance.

The image processing apparatus 10 (display controller 244) can arbitrarily change the curvature of a video image displayed on the display 115 in accordance with a signal from the remote controller 302. Namely, a user including the observer can manually change the curvature of a curved image displayed on the display 115, using the remote controller 302.

Furthermore, the image processing apparatus 10 can automatically set the position of the vertically smallest portion of the curved image and the curvature of the curved image, using the controller 113. As a result, when the observer is observing the display 115, the image processing apparatus 10 automatically detects the observation position and executes appropriate image processing in the observation position. This also enables the image processing apparatus 10 to provide a realistic curved video image and/or image of a wide view angle even when the user including the observer does not set it using, for example, the remote controller 302.

Yet further, although in the first embodiment, the image processing apparatus 10 incorporates the display 115, they may be separate units. In the latter case, the image processing apparatus 10 is connected to the display 115, and outputs a resultant curved image to the display 115.

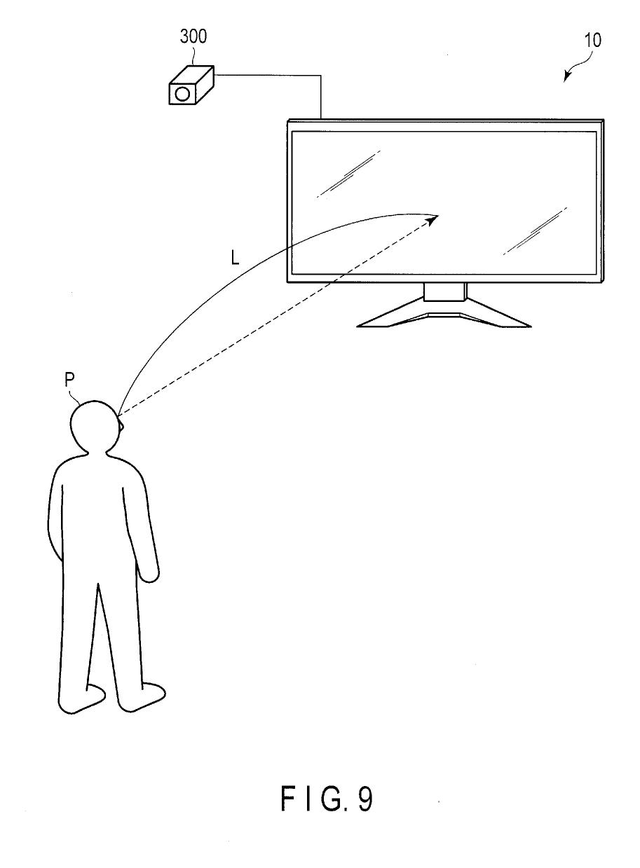

Although in the first embodiment, the detector 300 is incorporated in the image processing apparatus 10, it may be separate from the image processing apparatus 10 as shown in FIG. 9. In this case, the detector 300 can communicate with the image processing apparatus 10 by radio or fixed line via the network controller 122 and the communication unit 304. If the detector 300 is located in a position in which it can more easily detect the observer than where it is incorporated in the image processing apparatus 10, it can more accurately detect the positional relationship between the observation position and the display 115. As a result, the image processing apparatus 10 can output a curved video image more suitable for the positional relationship between the observation position and the display 115.

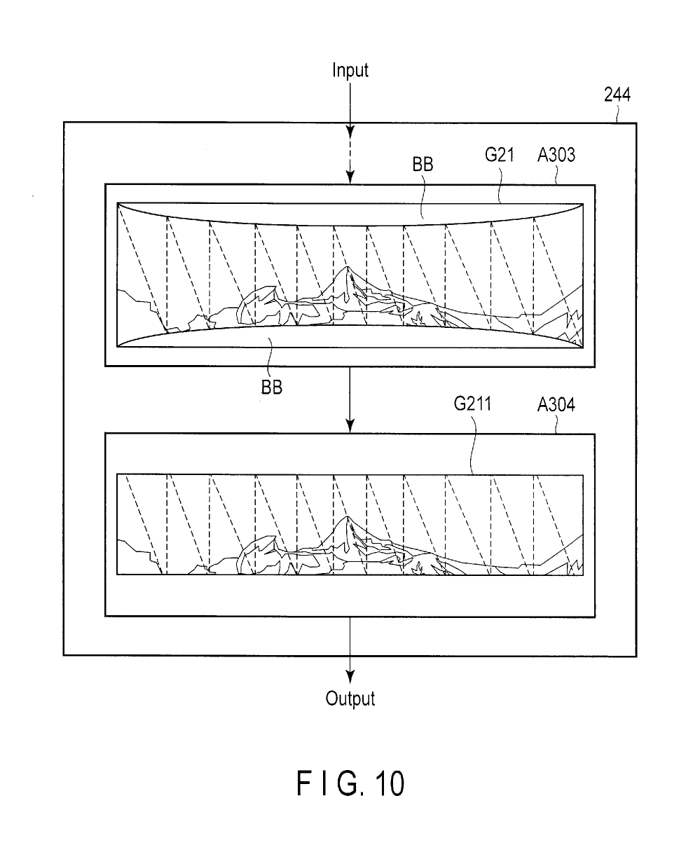

Also, the display controller 244 may further incorporate image processing A304 for performing processing on each secondary image in image processing A303 so as not to display the blank spaces of a rearranged image as shown in FIG. 10. In image processing A304, the display controller 244 processes image G21 so as not to display blank spaces that occur above and below the image, thereby outputting image G211 with no blank spaces to the display 115. For instance, the display controller 244 enlarges the curved image constructed not to display blank spaces. As a result, the image processing apparatus 10 can provide a clearer image than where the image includes blank space.

An image processing apparatus according to a second embodiment will be described. In the second embodiment, elements similar to those of the first embodiment are denoted by corresponding reference numbers, and no detailed description will be given thereof.

### Second Embodiment

The second embodiment will be described with reference to the accompanying drawings.

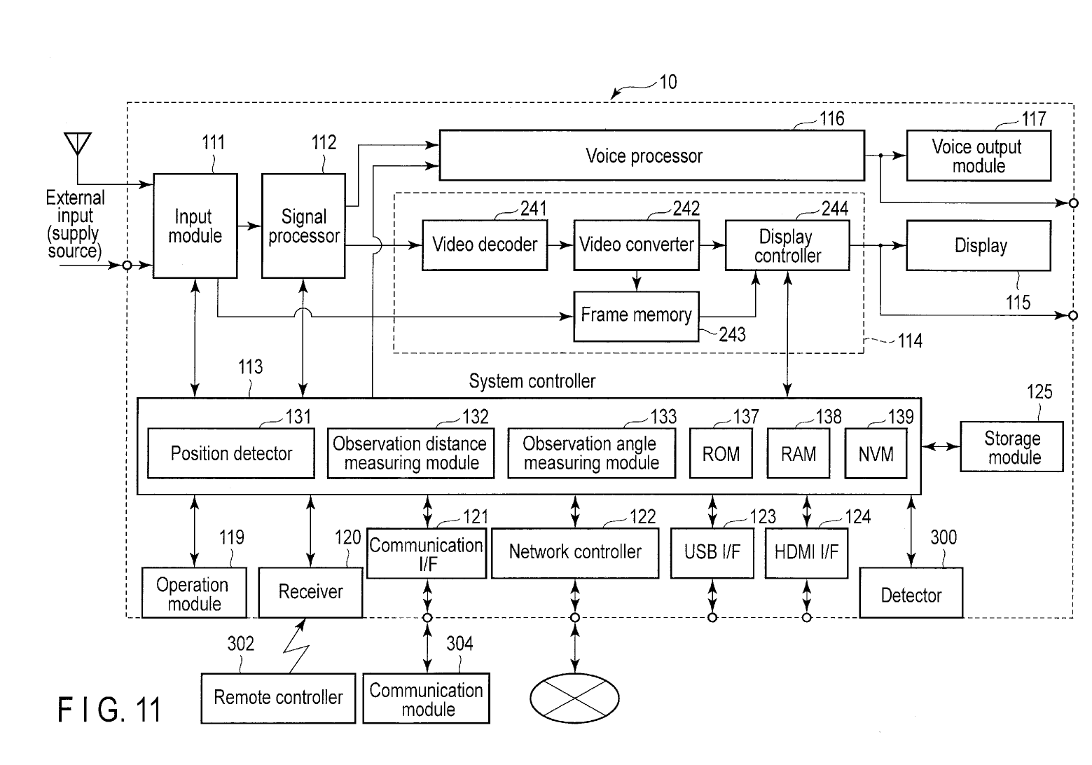

FIG. 11 is a block diagram showing the configuration of an image processing apparatus according to the second embodiment.

As shown in FIG. 11, the controller 113 of the image processing apparatus 10 according to the second embodiment further comprises an observation angle measuring unit 133.

The observation angle measuring unit 133 detects the orientation of an arbitrarily or automatically set object. The observation angle measuring unit 133 sets an observed portion (observation point) based on the detected orientation of the object. Further, the observation angle measuring unit 133 can determine whether the observation point is on the display 115. If the observation point is on the display 115 for a predetermined period or more, the observation angle measuring unit 133 determines that the display is being observed. The predetermined period may be predetermined, or be arbitrarily set by the user. The controller 113 outputs, to the display controller 244, a signal indicative of the position of a curved image including the observation point.

For instance, the observation angle measuring unit 133 detects the orientation of the face of the observer and the eyes (line of sight) of the observer to thereby estimate the position of the line of sight in the display area of the display 115. The observation angle measuring unit 133 sets, as the observation point, a point in the display area of the display 115, which the observer is supposed to be observing. The observation angle measuring unit 133 outputs the area of a curved image located at the set observation point. The controller 113 outputs, to the display controller 244, a signal indicative of the position of the curved image including the set observation point.

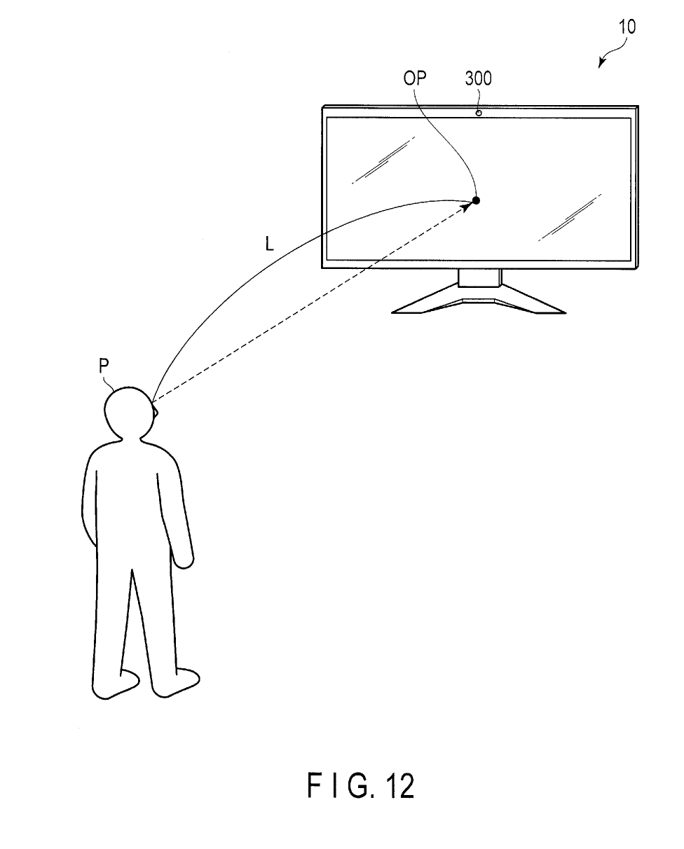

FIG. 12 is a schematic view showing an example case where the observer stands in front of an image processing apparatus 10. Assume here that the observer is observing an observation point OP as the center of the display 115 and its vicinity in a position P a distance L from the display 115. More specifically, assume that the observer exists in a direction perpendicular to the center of the display 115.

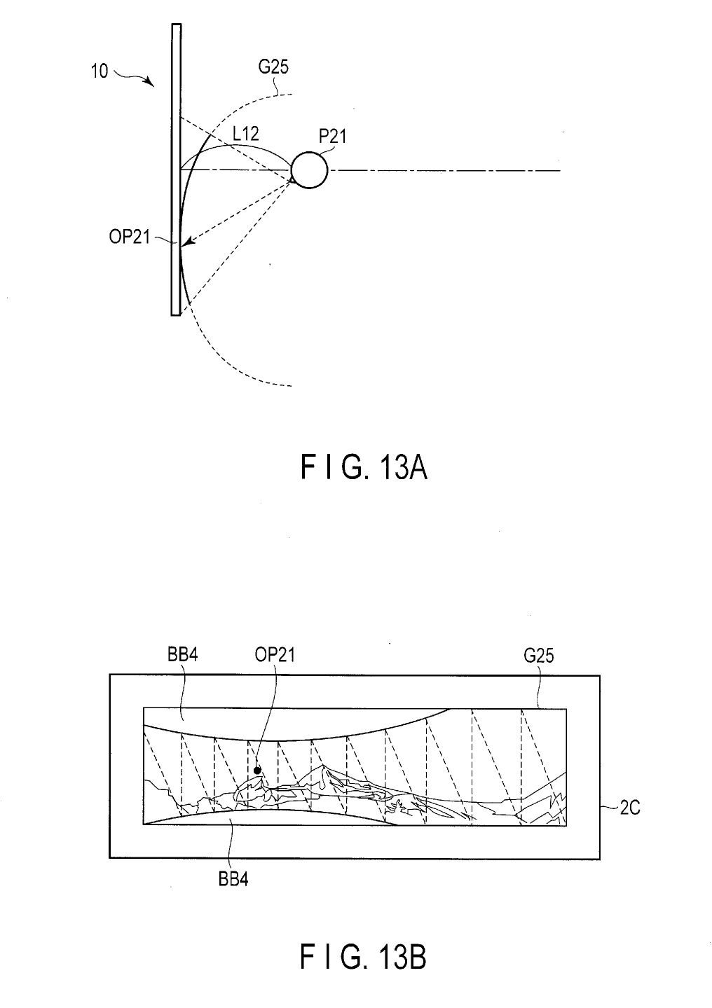

FIG. 13A is a schematic view for explaining an example of a curved image obtained when an observer exists near the display 115. FIG. 13B shows the curved image example obtained in the case of FIG. 13A. In FIGS. 13A and 13B, assume that the conditions other than the orientation of the face of the observer and the line of sight of the observer are substantially the same as those of FIGS. 6A and 6B.

In FIG. 13A, the observer exists in position P21 perpendicular to the center of the display 115 as in the case of FIG. 6A. FIG. 13A shows that the observer has changed the angle of the face and the line of sight thereof by a certain angle from the state of FIG. 6A. Namely, the observer is observing curved image G25 displayed on the display 115 near observation point OP21 to which the line of sight of the observer has been moved from the observation point OP on the display 115 by the certain angle. Assume that observation point OP21 is at perpendicular distance L12 from the center of the display 115. The curvature of processed curved image G25 is 1/L12 as in the case of FIG. 6A. Observation point OP21 is substantially the same as observation point OP12 of FIG. 6A.

As shown in FIG. 13B, the display controller 244 makes a curved video image to be curved such that it is greatly curved from observation point OP21 to one end of the picture positioned far away from observation point OP21, and is slightly curved to the other end positioned near observation point OP21. Further, when observation point OP21 is set, the controller 113 constructs the curved image so that the image portion including observation point OP21 serves as the vertically smallest portion of the image, as is shown in FIG. 13B. Yet further, each black band BB4 of the displayed video image is curved so that it is narrowed as it is longitudinally away from observation point OP21, as is shown in FIG. 13B.

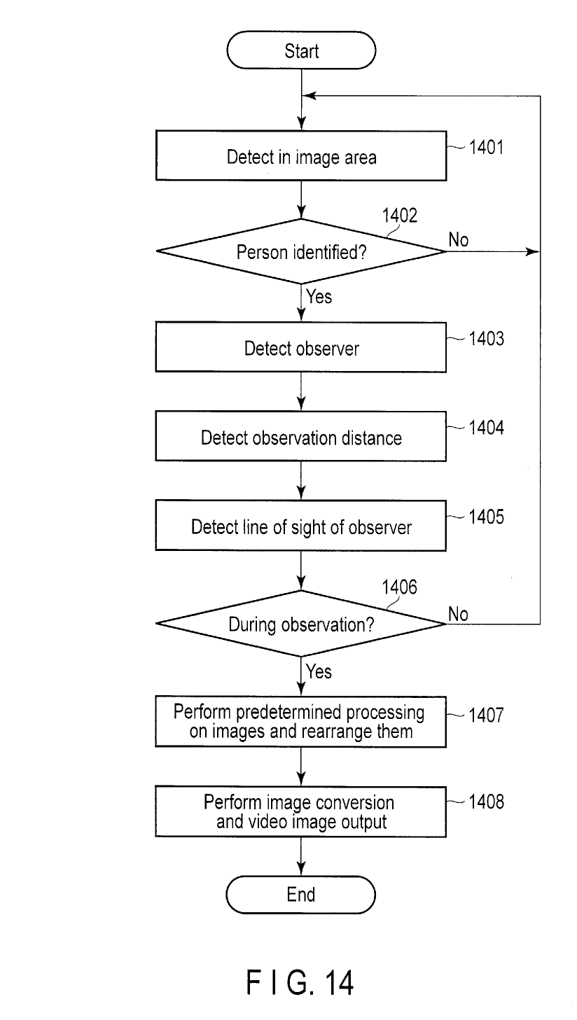

Referring then to FIG. 14, a description will be given of a method of automatically setting the curvature of a curved video image in accordance with an instruction from the controller 113, based on the detection data of the detector 300.

FIG. 14 is a flowchart for setting the curvature of a curved video image in accordance with the observation position.

In B1401, the position detector 131 of the controller 113 detects an object in a detection area using the detector 300. The position detector 131 detects an object in, for example, a detector area detected in a real-time manner by the detector 300.

In B1402, the position detector 131 identifies (detects) a person in the detected object (Yes in B1402), it proceeds to subsequent processing (B1403). If no person is detected (No in B1402), the position detector 131 re-attempts to identify a person in the detection area from the detected object.

In B1403, the position detector 131 detects whether the detected person is observing the display 115. If the person is observing the display 115, the position detector 131 sets this person as an observer.

Subsequently, in B1404, the observation distance measuring unit 132 of the controller 113 sets, as an observation distance, the distance between the observation position and the display 115 based on the information acquired by the position detector 131, and calculates the observation distance from the detection data acquired by the detector 300.

In B1405, the observation angle measuring unit 133 of the controller 113 detects the orientation of the face of the observer and the line of sight of the observer from the detection data of the detector 300, thereby setting an observation point.

In B1406, the observation angle measuring unit 133 determines whether the observation point is kept on the display 115 for a predetermined period of time, thereby determining whether the observer is observing the display 115. If it is determined that the observer is observing the display 115 (Yes in B1406), the observation angle measuring unit 133 proceeds to subsequent processing (B1407). In contrast, if it is not determined that the observer is observing the display 115 (No in B1406), the observation angle measuring unit 133 returns to processing of B1401.

In B1407, the display controller 244 defines, as primary images, images acquired from the frame memory 243 in respective zones under the control of the controller 113, and executes predetermined processing on each primary image. Further, the display controller 244 appropriately rearranges secondary images resulting from predetermined processing, thereby providing a set of rearranged secondary images as a curved image. At this time, the display controller 244 provides a secondary image including the set observation point as the vertically smallest portion of the curved image.

In B1408, the display controller 244 outputs a display signal indicative of the processed image to the display 115.

In the second embodiment, the image processing apparatus 10 can set the curvature of a curved image and the vertically smallest portion of the curved image in accordance with the orientation of the face of the observer and the line of sight of the observer. When the observer is observing the display 115, the image processing apparatus 10 can detect an observation point on the displayed image, and reset the position of the vertically smallest portion of the curved image, which enables an appropriate curved video image to be output. As a result, the image processing apparatus 10 can provide a realistic curved video image or curved image of a wide view angle, regardless of the orientation of the face of the observer or the line of sight of the observer.

An image processing apparatus according to a third embodiment will be described. In the third embodiment, elements similar to those of the second embodiment are denoted by corresponding reference numbers, and no detailed description will be given thereof.

### Third Embodiment

A description will be given of the third embodiment with reference to the accompanying drawings.

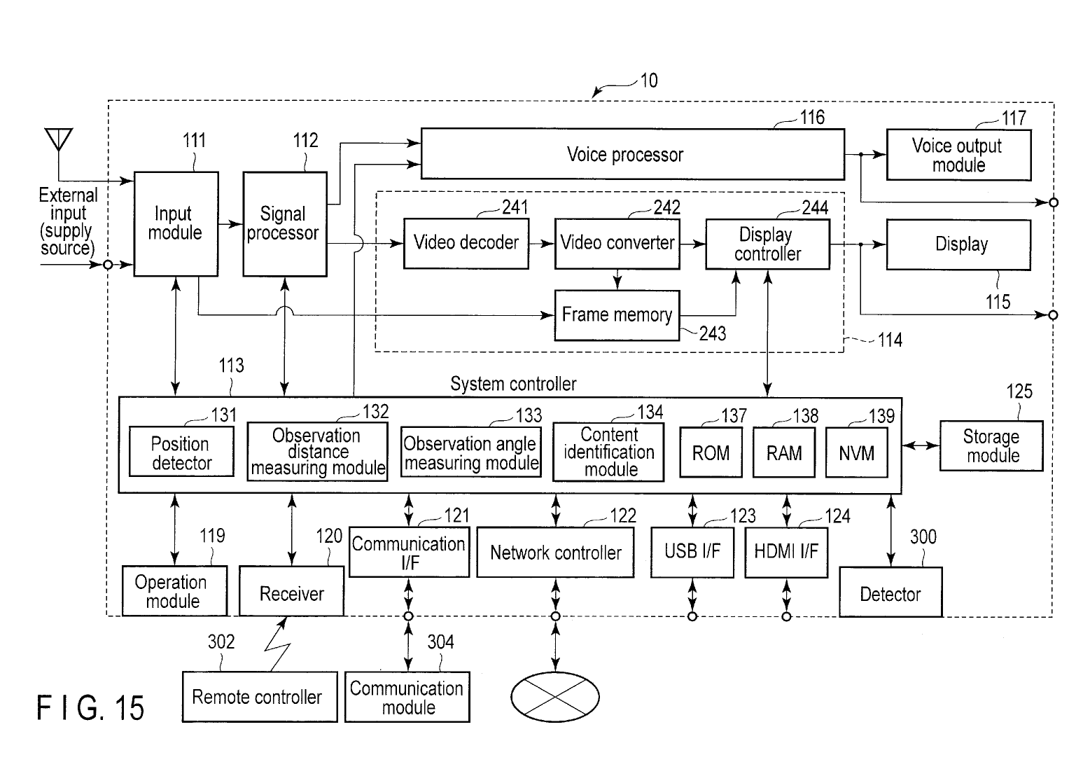

FIG. 15 is a block diagram showing a configuration of an image processing apparatus according to the third embodiment.

In an image processing apparatus 10 according to the third embodiment, the controller 113 further comprises a content identification unit 134 as shown in FIG. 15.

The content identification unit 134 identifies the type of arbitrarily or predetermined set scene/content. The content identification unit 134 outputs, to the display controller 244, curvature information indicative of the curvature of a curved image suitable for viewing a scene and content. The curvature information is preset and stored in the storage unit 125. Alternatively, the curvature information can be added arbitrarily. If it is added, it is stored in the storage unit 125.

The content identification unit 134 identifies the type of content (variety shows, sports, movies, news, etc.) based on, for example, program collateral information acquired from, for example, an electronic program table, and outputs curvature information corresponding to the identified type. At this time, the controller 113 arbitrarily or automatically changes the ON/OFF state of a curved video image or the curvature of the image in accordance with the content/scene.

In the case of an externally input video image, the content identification unit 134 identifies an input system and outputs curvature information corresponding to the identified input system. In this case, the controller 113 can set the ON/OFF state of a curved video image or the curvature of the image in accordance with the identified input system, for example, the input system of a player. The curvature information corresponding to the input system is preset and stored in the storage unit 125.

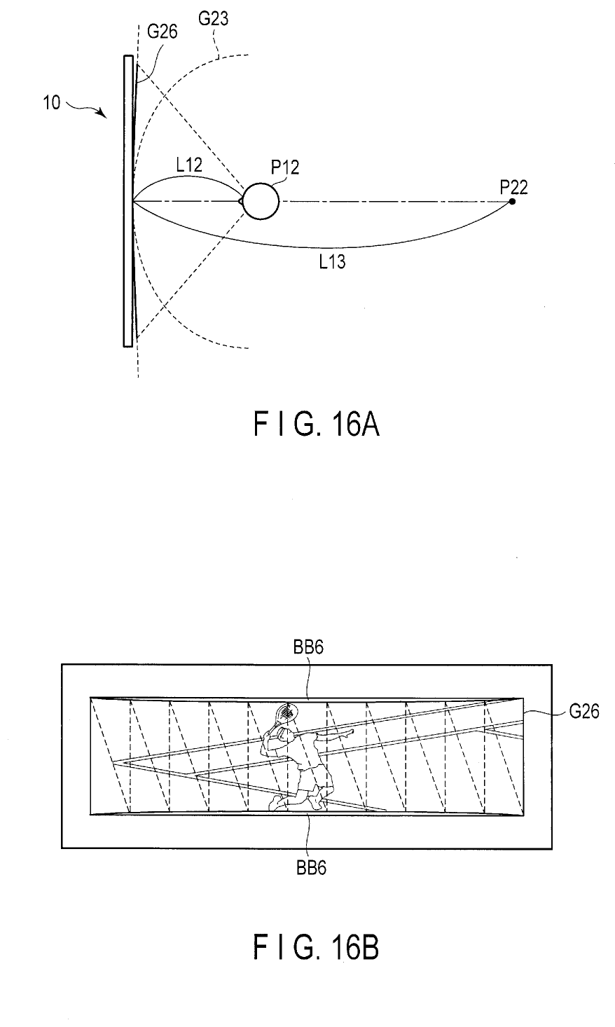

FIG. 16A is a schematic view for explaining an example of a curved video image obtained when content to display has been changed. FIG. 16B shows the curved video image example obtained in the case of FIG. 16A. In FIGS. 16A and 16B, assume that the conditions other than the scene or content displayed on the display 115 are substantially the same as those shown in FIGS. 6A and 6B.

In FIG. 16A, the observer exists in position P12 perpendicular to the center of the display 115 as in the case of FIG. 6A. Further, in FIG. 16A, the observer is observing the center of the display 115 and its vicinity as in the case of FIG. 6A. FIG. 16A shows image G23 in the display scene of the content shown in FIG. 6A, and image G26 in the display scene of content different from that of FIG. 6A.

For instance, when the display scene is changed from image G23 to image G26 as shown in FIG. 16A, the curved image is arbitrarily reset or is automatically reset by the controller 113 to a curvature suitable for the type of the display scene. Assume here that the curvature radius of image G23 is distance L12 between the center of the display 115 and position P12, and the curvature radius of image G26 is distance L13 between the center of the display 115 and position P22. Accordingly, when the display image is changed from image G23 to image G26, the display controller 224 changes the curvature of the curved video image from 1/L12 to 1/L13. Thus, when the curvature of the curved video image is changed in accordance with a change in the type of the display scene/content, only the curvature is changed, with the observer kept in position P22.

In FIG. 16B, the display controller 244 constructs curved image G26 so as to curve from the vertically smallest position of the image to the opposite ends of the image along the longitudinal axis to have a smaller curvature than curved image G23. In this case, the display controller 244 makes black band BB6 of image G26 smaller than black band BB2 of image G23, as shown in FIG. 16B.

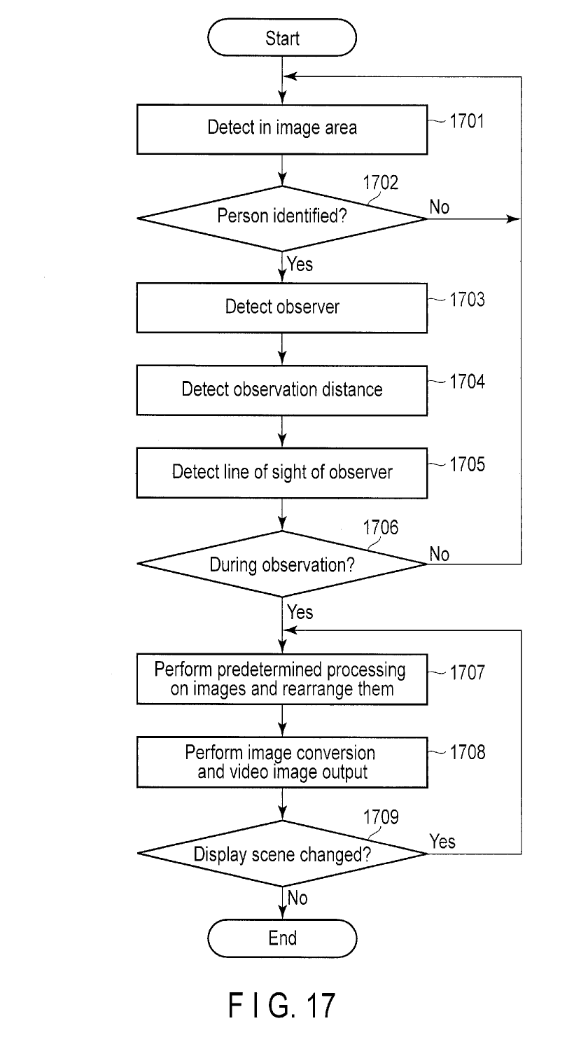

Referring then to FIG. 17, a description will be given of a method of automatically setting the curvature of a curved video image using the controller 113, based on detection data obtained by the detector 300.

FIG. 17 is a flowchart for causing the controller 113 to set the curvature of a curved video image in accordance with the type of content to display.

In B1701, the position detector 131 of the controller 113 detects an object in a detection area detected by the detector 300. The position detector 131 detects an object in, for example, a detector area or an image detected in a real-time manner by the detector 300.

In B1702, the position detector 131 identifies (detects) a person in the detected object (Yes in B1702), it proceeds to subsequent processing (B1703). If no person is detected (No in B1702), the position detector 131 re-attempts to identify a person in the detection area from the detected object.

In B1703, the position detector 131 detects whether the detected person is observing the display 115. If the person is observing the display 115, the position detector 131 sets this person as an observer.

Subsequently, in B1704, the observation distance measuring unit 132 of the controller 113 sets, as an observation distance, the distance between the observation position and the display 115 based on the information acquired by the position detector 131, and calculates the observation distance from the detection data acquired by the detector 300.

In B1705, the observation angle measuring unit 133 of the controller 113 detects the orientation of the face of the observer and the line of sight of the observer from the detection data of the detector 300, thereby setting an observation point.

In B1706, the observation angle measuring unit 133 determines whether the observation point is on the display 115, thereby determining whether the observer is observing the display 115. If it is determined that the observer is observing the display 115 (Yes in B1706), the observation angle measuring unit 133 proceeds to subsequent processing (B1707). In contrast, if it is not determined that the observer is observing the display 115 (No in B1706), the observation angle measuring unit 133 returns to processing of B1701.

In B1707, the display controller 244 defines, as primary images, images acquired from the frame memory 243 in respective zones under the control of the controller 113, and executes predetermined processing on each primary image. Further, the display controller 244 appropriately rearranges secondary images resulting from predetermined processing, thereby providing a set of rearranged secondary images as a curved image.

In B1708, the display controller 244 outputs a display signal indicative of the processed image to the display 115.

In B1709, the controller 113 determines whether the display scene displayed on the display 115 has been changed. If it is determined that the display scene has been changed (Yes in B1709), the controller 113 returns to B1707, thereby changing, for example, the curvature of the image displayed by the display controller 244. If it is determined that the display scene is unchanged (No in B1709), the controller 113 finishes the processing.

In the third embodiment, the image processing apparatus 10 can set the curvature of the curved image in accordance with a display scene or display content. As a result, the image processing apparatus 10 can provide a realistic curved video image or curved image of a wide view angle suitable for the display scene or content.

In the third embodiment, the image processing apparatus 10 displays a curved video image on the flat display 115. Further, the image processing apparatus 10 executes predetermined processing on each of partial images obtained by dividing processing using polygons, in accordance with an instruction from the controller 113, and appropriately rearranges the processed images to form a smooth curved image. The image processing apparatus 10 displays the curved image as a curved video image on the display 115. As a result, the image processing apparatus 10 can provide a realistic video image of a wide view angle.

Further, the image processing apparatus 10 can arbitrarily set the curvature of a curved image and the vertically smallest portion of the image, which are referred to for curving. This enables an observer to set a curvature in accordance with their taste, regardless of the observation distance.

The image processing apparatus 10 (display controller 244) can arbitrarily change the curvature of a video image displayed on the display 115 in accordance with a signal from the remote controller 302. Namely, a user including the observer can manually change the curvature of a video image displayed on the display 115, using the remote controller 302.

Yet further, the image processing apparatus 10 can appropriately set the curvature of a curved image and the vertically smallest portion of the image, which are referred to for curving. This enables the image processing apparatus 10 to automatically detect an observer who is observing the display 115, and to automatically execute appropriate processing on a video image in accordance with the detected observer. As a result, the image processing apparatus 10 can also provide a realistic curved image and curved image of a wide view angle, even if a user including an observer does not perform setting using, for example, the remote controller 302.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a display formed of a flat panel and configured to display a video image; and
a display controller configured to generate a curved image and output, to the display, a display signal for displaying the curved image, the curved image being obtained by reducing and deforming an input image included in an input video signal in accordance with a horizontal position of the input image, to curve the input image perpendicularly,
wherein the display controller reduces the input image by a maximum reduction ratio in a predetermined horizontal position, and reduces the input image by a smaller reduction ratio in a horizontal position remoter from the predetermined horizontal position.

2. The image processing apparatus of claim 1, wherein the display controller is configured to change a curvature as a ratio of curving of the curved image.

3. The image processing apparatus of claim 2, further comprising a position detector configured to obtain position information indicative of an observation position in which the display is observed,
wherein the display controller changes the predetermined horizontal position in which the input image is reduced by the maximum reduction ratio, based on the position information.

4. The image processing apparatus of claim 3, further comprising an observation distance measuring unit configured to calculate an observation distance as a distance between the display and the observation position,
wherein the display controller changes the predetermined horizontal position in which the input image is reduced by the maximum reduction ratio, based on the observation distance.

5. The image processing apparatus of claim 4, further comprising an observation angle measuring unit configured to obtain angle information indicative of an angle at which the display is observed in the observation position,
wherein the display controller changes the predetermined horizontal position in which the input image is reduced by the maximum reduction ratio, in accordance with the angle information.

6. The image processing apparatus of claim 5, wherein the display controller changes the predetermined position in which the input image is reduced by the maximum reduction ratio, in accordance with curvature information associated with the curvature and suitable for a type of content.

7. The image processing apparatus of claim 6, wherein the display controller provides a back band in a blank portion of a display area of the display, in which no curved image is displayed.

8. The image processing apparatus of claim 1, wherein when the input image is divided into predetermined zones, the display controller divides the input image using triangular polygons.

9. The image processing apparatus of claim 8, wherein when the input image is divided into the predetermined zones defined by the triangular polygons, the display controller sets a larger number of zones, defined by a larger number of triangular polygons, for a portion of the input image that may be decreased in reduction ratio.

10. The image processing apparatus of claim 4, wherein the display controller increases a curvature of the curved image when the observation distance is short, and reduces the curvature of the curved image when the observation distance is long.

11. The image processing apparatus of claim 2, wherein the display controller is configured to change the curvature as the ratio of curving of the curved image in accordance with a signal output from an external terminal.
